(19) United States
(12) Patent Application Publication
(10) Pub. No.: US 2005/0168811 A1
(43) Pub. Date: Aug. 4, 2005

(54) Fork mounted telescope with full range of travel along the declination axis

(76) Inventor: Michael F. Mattei, Littleton, MA (US)

Correspondence Address: CESARI AND MCKENNA, LLP, 88 BLACK FALCON AVENUE, BOSTON, MA, 02210, US

(21) Appl. No.: 10/770,381

(22) Filed: Feb. 2, 2004

(51) Int. Cl. G02B 23/00; G02B 21/06

(52) U.S. Cl. 359/389; 359/430

(57) ABSTRACT

A telescope has a tube, a prime focusing mirror, and a secondary mirror to form a real image behind the telescope. A fork mount has a base and a two arms extending to hold the telescope tube. A 45 degree angle reflector deflects light from the telescope by 90 degrees. The 45 degree angle reflector attaches to external threads at an end of the telescope tube. A cylindrical coupling member mates at a first end with a downstream opening of the 45 degree angle deflector, and has a threaded coupling at a downstream end of the cylindrical coupling. A field adjuster attaches to the threaded coupling of the cylindrical coupling member. A CCD camera attaches to a downstream end of the field adjuster, so that the CCD camera clears the base of the fork mount when the telescope is in the 90 degree declination position.

### BACKGROUND

Fork mounted telescopes are commercially available in the amateur astronomy telescope market. In a popular form of fork mounting, the arms of the fork have supports at their free ends for the tube of the telescope; and the base of the fork is attached to a rotatable axle, and the axis of the rotatable axle is parallel to the arms of the fork. When the telescope is used, the rotatable axle is aligned with the axis of rotation of the Earth, so that rotation about the axle swings the telescope along the coordinates of right ascension, and this axle will be referred to as the right ascension axle (RA axle). Rotation of the telescope about the supports at the free ends of the arms of the forks swings the telescope through the coordinates of declination, and this rotation will be referred to as rotation about the declination axle (DEC axle).

The telescope may use a primary focusing mirror as the light gathering element, in which case it is referred to as a reflecting telescope, or the telescope may use an objective lens as the primary light gathering element. The mirror or lens then forms a real image, referred to as a primary image. The primary image may be examined by an eyepiece for visual observations, may be cast onto photographic film to produce a photograph, or may be cast onto a charge coupled device (CCD) to produce digital images, or may be cast into a television camera, etc.

Further, the telescope may be of the Cassegrain type, in which a primary focusing mirror returns the light in the direction of the star being observed, and the light strikes a mirror centrally located in the telescope tube so that the light exits through a hole in the center of the primary focusing mirror to form the real primary image behind the primary focusing mirror. For example, the telescope may be a Schmidt Cassegrain system, or may be Maksutov Cassegrain Telescope, etc., and various types of telescope are described in detail in the book by H. Rutten and Martin van Venrooij, entitled Telescope Optics, Copyright 1988 and Copyright 2002, by Willmann-Bell, Inc. Richmond Va., U.S.A., all disclosures of which are incorporated herein by reference.

Optical elements are often used between the telescope mirror (and or lens) and the CCD detector. Commonly used optical elements include a field flattener, a focal length reducer, combination focal reducer/field flattener, focal length extender (Barlow lens), mechanical fittings to help assemble the apparatus, etc.

Observations of astronomical objects, such as planets, stars, galaxies, etc., can be made visually using the eyepiece, can be photographed using photographic film, can be recorded as digital images using a CCD device, can be recorded by a television camera as a stream of images, etc.

During observations a motor in the base of the telescope is arranged to drive the RA axle, aligned with the rotational axis of the Earth, at a rate which compensates for the rotation of the Earth, so that during the observation the telescope points toward a selected region of the sky. An observation may be for a few seconds, or can be as long as several hours, etc., and throughout the observation the telescope remains pointing toward the selected region of sky as the rotation about the axle compensates for the rotation of the Earth. Guiding of the telescope is often done for visual correction of small errors in tracking of the desired region of sky. Guiding of the telescope is often accomplished by one of several methods: using a guide telescope; using a partially reflecting mirror to send some of the light to an eyepiece for visual guiding; or alternatively a CCD detector may be used to observe a guide star and the guiding accomplished electronically, etc.

Modern amateur astronomy telescopes are made with a computer built into the telescope, along with a motor to rotate the axle aligned with the arms of the fork mount, and a motor which rotates the telescope about the declination axle, that is about the supports at the free ends of the arms of the fork mount. Additionally, the computer has a table of stars, planets, galaxies, etc. by name, and by the coordinate right ascension (RA) and the coordinate declination (DEC). Using an input interface to the computer, a user can select a star, planet, galaxy, etc. by name as a selected object, command the telescope to go-to the object, and the computer drives the motors to the selected right ascension and declination and so brings the selected object into the field of view of the telescope.

Transducers built into the telescope mount measure the angular positions of the two axles of rotation. The right ascension transducers (RA transducers) measure angular position about the axle parallel to the forks of the mount. The declination transducers (DEC transducers) measure the angular position of the tube of the telescope about the declination axle.

Before observations are begun, it is necessary to align the telescope so that the axle which is parallel to the forks of the mount is aligned with the rotation axis of the Earth, and to calibrate transducers within the telescope so that they correctly read right ascension and declination. Alignment of the axle is accomplished by, first, rotating the telescope so that the tube is parallel to the forks of the mount, and then adjusting the azimuth and elevation of the mount so that the telescope points toward Polaris, also known as the North Star, thereby pointing the arms of the fork mount toward Polaris. Pointing the arms of the fork mount toward Polaris brings the axle of rotation of the fork mount near to parallel to the axis of rotation of the Earth, because Polaris lies near a line projected along the axis of rotation of the Earth. The declination settings of the telescope and computer are next adjusted by commanding the computer to point the telescope to a star of known location, in order to calibrate the RA transducers and the DEC transducers. Polaris lies at right ascension 2 hours 32.2 minutes and declination 89.16 degrees (Epoch 2000.5), and so is about 0.84 degree away from the axis of rotation of the Earth. A sequence of further adjustments are then done to iterate the azimuth and elevation of the mount in order to bring the arms of the fork into a position parallel to the rotation axis of the Earth, and to calibrate the transducers.

The sequence of adjustments which are done to iterate the azimuth and elevation of the mount so that the arms of the fork are aligned parallel to the axis of rotation of the Earth are done to accomplish two desirable goals, the first goal is to align the forks with the axis of rotation of the Earth, and the second goal is to calibrate the transducers in the mount so that they correctly read right ascension and declination. One exemplary set of a sequence of steps to align the mount and calibrate the transducers follow, for use in the Northern Hemisphere.

Step 1: using a bubble level, bring horizontal portions of the mount into a “level” position, that is perpendicular to a line drawn from the center of the Earth through the location of the telescope on the surface of the Earth (assuming a spherical homogenous Earth).

Step 2: point the tube of the telescope parallel to the arms of the fork mount. This adjustment is done by commanding the computer to bring the telescope to 90 degrees declination.

Step 3: adjust the azimuth and elevation of the mount so that the telescope points toward Polaris. This adjustment is done by, first pointing the tube toward Polaris by sighting along the tube of the telescope, and after an image of Polaris can be observed through the telescope, observing Polaris through the telescope while adjusting screws which provide fine mechanical adjustment of the azimuth and elevation of the mount.

Step 4: Command the telescope to point to a known bright star whose right ascension and declination are known. The telescope will move by the computer commanding the motors to rotate the telescope about the right ascension axle and the declination axle. The telescope, on this first try, may go wide of the desired direction to the bright star.

Step 5: Use hand controls to have the computer operate the motors to bring the known bright star into the center of the image produced by the telescope. The computer then thinks that the RA transducer and the DEC transducer are reading the RA and the DEC of the bright star.

Step 6: Command the computer to bring the telescope to Polaris. Polaris will not be in the center of the image because it is not on the axis of rotation of the Earth, and so use the mechanical fine adjustments of azimuth and elevation of the mount to bring Polaris into the center of the image produced by the telescope.

Step 7: Command the computer to return the telescope to the known bright star. The star will not be in the center of the image because the mechanical adjustments of the mount have been moved in the previous step. Use the manual controls to have the computer operate the motors to bring the bright star into the center of the image produced by the telescope. Again, the computer will think that the RA and DEC transducers are reading the RA and DEC of the bright star.

Step 8: Command the computer to bring the telescope to Polaris. Polaris will not be quite at the center of the image. Again adjust the mechanical adjustments of azimuth and elevation of the mount to bring Polaris into the center of the image.

Step 9: Command the computer to bring the telescope to the bright star. Again, use the manual computer controls to bring the bright star into the center of the image by use of the motors.

Further steps: Continue returning to Polaris and use the mechanical adjustments of the mount azimuth and elevation to bring Polaris into the center of the image; and returning to the bright star and using the electronic commands to the computer to bring the bright star into the center of the image.

The adjustments on Polaris align the azimuth and elevation of the mount; adjustments on the bright star calibrate the transducers to correctly read right ascension (RA transducer) and declination (DEC transducer).

In some exemplary embodiments of the invention, it is advantageous to make the mechanical adjustments of the mount to bring Polaris only half way back to the center of the image from its position when returning from the bright star, in order to come to a desired degree of accuracy in the iteration process in a minimum number of iteration steps.

In the Southern Hemisphere, rather than use Polaris, it is necessary to use a star near the Southern Celestial Pole.

As these alignment steps are done, it is necessary to bring the tube of the telescope parallel to the arms of the fork mount, and in that position observe the image of Polaris. This observation of Polaris can be done visually by use of an eyepiece. Alternatively, it is desirable to make this observation by use of a CCD detector. By using a CCD detector, the image produced by the telescope can be displayed on a computer screen, on a television screen, etc., as a convenience in observation.

A problem with the use of a CCD detector is that the physical length of the optical elements attached to the rear of the telescope to couple the telescope to the CCD detector is often greater than the clearance between the end of the telescope tube and the base of the fork mount. That is, as an attempt is made to swing the telescope into the 90 degree declination position, the CCD detector strikes the base of the fork mount, and so jams the motor which swings the telescope about the declination axle.

Also, it is desirable to observe astronomical objects which are near a declination of 90 degrees, and the CCD detector strikes the arm of the fork mount at values of declination near 90 degrees.

A further problem with the use of a CCD detector to align the telescope or to observe astronomical objects near a declination of 90 degrees, is that commercially available mirror optical elements which can deflect the image to a right angle to the axis of the tube of the telescope are designed to accept an eyepiece. With an eyepiece a user can visually observe with the telescope adjusted to 90 degrees declination. In being designed to accept an eyepiece, the mirror optical element cannot accept a CCD detector. Thus, with commercially available mirror optical elements, the image can be viewed visually at right angles to the axis of the tube of the telescope, but a CCD camera cannot be mounted to the mirror optical element. Therefore, with commercially available optical elements, it is not possible to either align a telescope, or to observe astronomical objects near 90 degrees declination using a CCD detector.

### SUMMARY OF THE INVENTION

The invention is a coupling which allows a CCD camera, along with other optical elements, to be attached to a mirror optical element so that the CCD camera can be used to observe objects near, or at, 90 degrees declination by clearing the base of the fork mount.

In an exemplary embodiment of the invention, a mirror optical element is attached to threads provided at the rear of the telescope tube, and the mirror optical element has a sliding female socket designed to accept an eyepiece. The eyepiece is oriented at right angles to the axis of the tube of the telescope, so that the eyepiece and the mirror optical element clear the base of the fork mount when the telescope is brought into a declination position near 90 degrees declination. The inventive coupling fits into the eyepiece sliding female socket of the mirror optical element at a first end of the inventive coupling, and at a second end of the inventive coupling a threaded end couples to a threaded optical element such as a field flattener, focal length adjuster, combination focal reducer/field flattener, CCD camera, etc. Alternatively, a focal length adjuster attaches to the threaded inventive coupler and the CCD camera attaches downstream from the focal length adjuster, etc. The entire assembly then clears the base of the fork mount when the telescope is swung into, or near, the 90 degree declination position. Also, the sliding female socket of the mirror optical element has a setscrew which engages a v-shaped grove formed into the sliding first end of the inventive coupling, the setscrew and grove interacting to keep the female socket of the mirror optical element locked into a stable relationship with the sliding first end of the inventive coupling. Other and further aspects of the present invention will become apparent during the course of the following description and by reference to the accompanying drawings.

### BRIEF DESCRIPTION OF THE DRAWINGS

Referring now to the drawings, in which like numerals represent like parts in the several views:

FIG. 1A is a side view of the Earth showing a telescope aligned parallel to the rotation axis of the Earth.

FIG. 1B shows altitude adjustment of a telescope mount, in side view;

FIG. 2 shows azimuth adjustment of a telescope mount, in top view;

FIG. 3 is a side view of a telescope showing a plurality of optical elements attached at the prime focus of a telescope supported by a fork mount;

FIG. 4 is a close up of optical elements attached at the prime focus of a telescope;

FIG. 5 is a cross section drawing of optical elements attached at the prime focus of a telescope;

FIG. 6 is a drawing showing optical elements attached at the prime focus of a telescope colliding with the base of a fork mount near a declination setting of 90 degrees;

FIG. 7 is a drawing showing the invention with optical elements attached at the prime focus of a telescope;

FIG. 8 is an exploded drawing showing the inventive optical elements;

FIG. 9 is a an exploded cross sectional drawing showing the inventive optical elements;

FIG. 10 is an exploded drawing of the inventive optical elements;

FIG. 11 is a side view showing the inventive optical elements clearing the base of the fork mount at a declination setting of 90 degrees;

FIG. 12 is an end view showing the inventive optical elements clearing the base of the fork mount at a declination setting of 90 degrees;

FIG. 13 is a side view showing an inventive telescope at the 90 degree declination position, with the inventive optical elements clearing the base of the fork mount;

FIG. 14 is an end view of a focal reducer with the inventive coupling attached;

FIG. 15 is a cross sectional ray diagram showing prior art coupling of optical elements at the prime focus of a telescope;

FIG. 16 is a cross sectional ray diagram of the inventive coupling of optical elements at the prime focus of a telescope;

FIG. 17 is a cross sectional drawing showing a prior art method of attaching a camera to a telescope by attachment through an eyepiece using a photographic “T” mount.

### SPECIFICATION

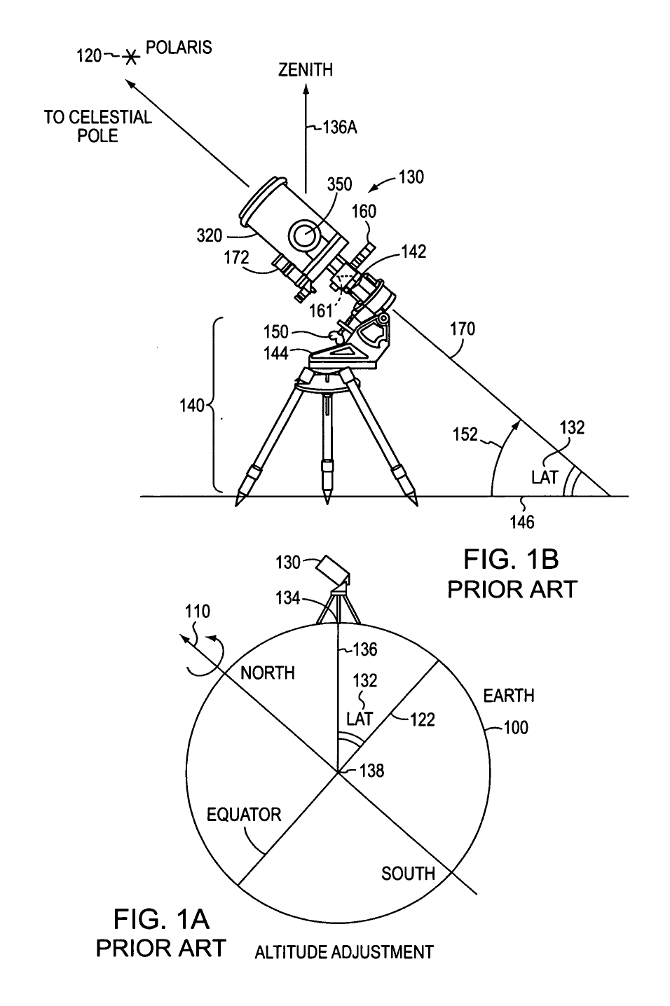

Referring now to FIG. 1A and FIG. 1B, Earth 100 is shown schematically with spin axis 110. Spin axis 110 points to the North Celestial Pole. Polaris 120 (FIG. 1B), Polaris, lies near the North Celestial Pole. Equator 122 is a plane perpendicular to spin axis 110, and is shown as a line in this schematic diagram of the Earth. An observer (not shown) has a telescope 130 located latitude 132, and location 134 on the surface of Earth 100. Line 136 (FIG. 1A) drawn from the center 138 of the Earth 100 points to the Zenith as line 136A, and line 136A (FIG. 1B) is an extension of line 136.

The mount 140 for telescope 130 is adjusted so that arms 142 of the mount point to the North Celestial Pole. In FIG. 1B the near arm is removed so that eyepiece 160 is visible in FIG. 1B. Horizontal surface 144 of mount 140 is adjusted to be level, that is parallel to a tangent plane 146 to the Earth at location 134, and perpendicular to the zenith line 136, 136A. The fork arms 142 of the mount 140 point at an elevation angle 152 equal to the latitude 132 when pointing toward the North Celestial Pole.

Screw 150 is shown schematically in FIG. 1B. Advancing screw 150 raises the elevation angle 152 at which the arms 142 point. Screw 150 provides fine adjustment of the elevation angle of the fork arms 142. Rotating screw 150 provides a way to adjust the elevation angle 152 to be equal to the latitude angle 132 of location 134, so that arms 142 can point toward the North Celestial Pole.

Eyepiece 160 is used to view Polaris, and to view any other astronomical object of interest. Mirror 161, which is hidden from view in FIG. 1B as shown by the dashed lead line 161, reflects the image at right angles to the optical axis of the telescope which lies along line 170, so that the eyepiece 160 can be used to view the image of the sky.

Rotation of the fork mount with fork arms 142 about the RA axis 170 swings the telescope through right ascension coordinates.

Finder scope 172 is a low power telescope with a cross hair reticle, and is adjusted to point to the same object as telescope 320. Finder scope 172 is an aid in pointing the main telescope 320 at a desired object.

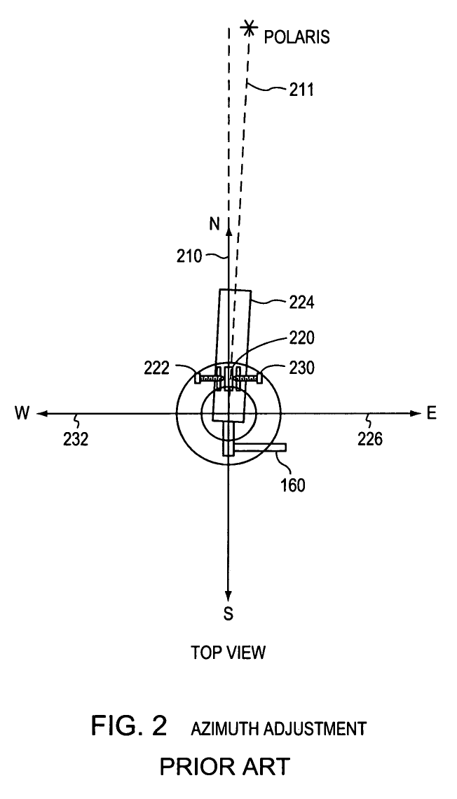

Turning now to FIG. 2, a top view showing adjustment of the azimuth of the telescope mount 140 so that the arms 142 (not shown in FIG. 2) of the fork mount point toward North 210, that is toward the North Celestial Pole, but in the tangent plane 146. Plate 220, shown in top view, is rigidly attached to the Earth (ground) at location 134. Advancing screw 222 shifts the mount to shift telescope 224 to point toward the East 226. Advancing screw 230 shifts the telescope 224 to point more toward the West 232.

Screw 222 and screw 230 provide fine adjustment of the azimuth 211 at which the arms 142 point, and are adjusted to bring the arms to point to the North, that is in the direction of the Celestial Pole as-projected on tangent plane 146.

Again, eyepiece 160 is used to view images of both Polaris and a bright star used in the adjustment procedure. An exemplary adjustment procedure is set out in the Background section of this patent application. Also, eyepiece 160 is used to observe interesting astronomical objects.

By adjusting the elevation angle 152 to equal the latitude of location 134, and adjusting azimuth 211, the telescope 130 can be adjusted to point toward the North Celestial Pole. The North Celestial Pole is the intersection point of the rotation axis of the Earth, as extended, with the Celestial Sphere.

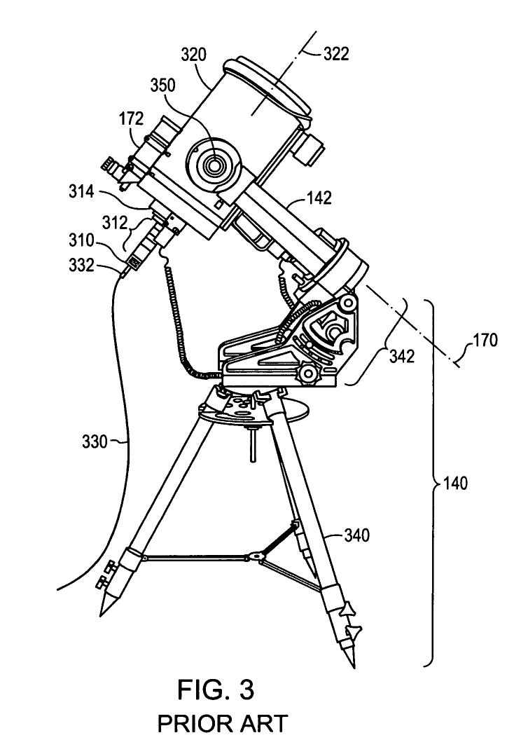

Turning now to FIG. 3, a charge coupled device (CCD) camera 310 is shown coupled to the telescope 320 along the optical axis 322 of telescope 320. Wire 330, a multiple conductor cable, is attached by a multiple conductor connector 332 to CCD camera 310, and wire 330 connects the CCD camera to its electronics package (not shown).

Additional optical elements 312 are mounted between end 314 of telescope 320 and the CCD camera 310.

Mount 140 is represented as a tripod supporting a fork mount 342 having fork arms 142. Only the near arm is visible in FIG. 3, as the distant arm is behind the near arm.

Rotation about axis 350 swings the telescope through declination coordinates. Rotation about axis 170, as noted earlier, swings the telescope 320 through right ascension coordinates.

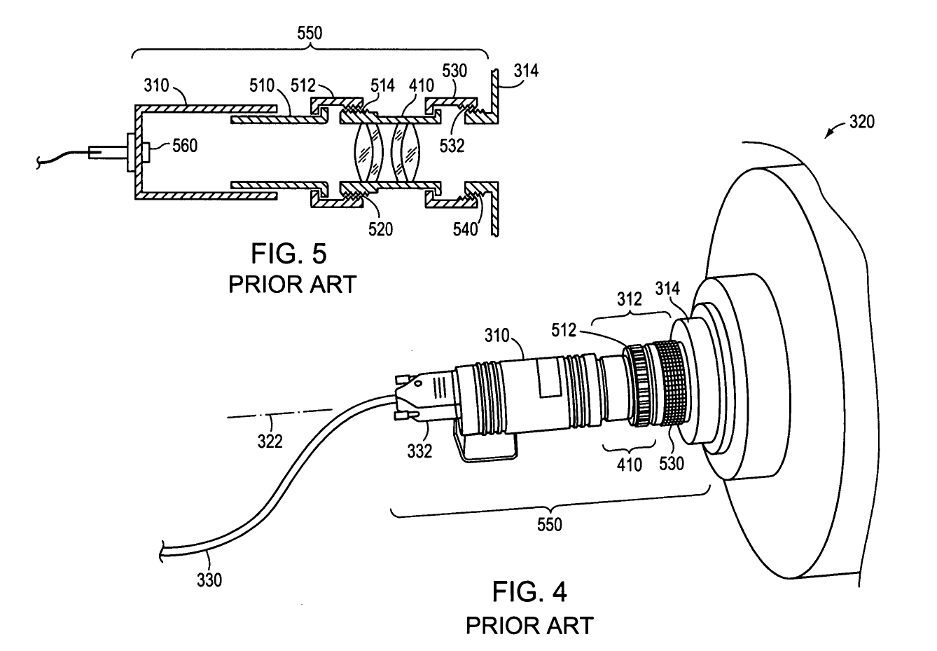

Turning now to FIG. 4, end 314 of telescope 320 is centered on the optical axis 322 of telescope 320. End 314 is attached to optical elements 312. Optical elements 312 include a combination focal reducer/field flattener 410.

Four lenses are shown in focal reducer/field flattener 410 for illustrative purposes. Fewer lenses, or more lenses could be employed as focal length adjusters and field flatteners, as further described in the book by Rutten, et al., referred to hereinabove.

CCD camera 310 attaches to combination focal reducer/field flattener 410. Wire 330 connects to CCD detector 310 by multi-conductor electrical connector 332.

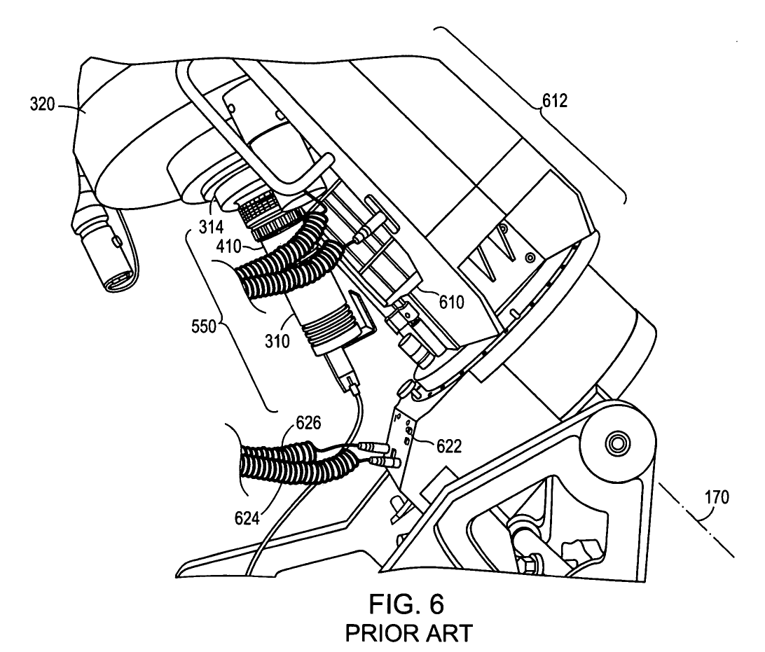

Turning now to FIG. 5, a cross sectional drawing of CCD camera 310, combination focal reducer/field flattener 410, and end 314 of telescope 320 are shown. CCD camera 560 is shown, in this exemplary embodiment, as being attached by sleeve 510 to focal reducer/field flattener 410. Sleeve 510 is attached by a screw arrangement by knurled nut 512 having internal threads 514 which mate with external threads 520 of focal reducer/field flattener 410.

Focal reducer/field flattener 410 is attached by knurled nut 530 to end 314 of the telescope 320, by internal threads 532 of knurled nut 530 mating with external threads 540 formed on end 314.

Accordingly, end 314 has internal threads 540 formed thereon, and the focal reducer/field flattener 410 has a nut which engages the internal threads 540. Again, focal reducer/field flattener 410 has internal threads 520 formed thereon, and CCD camera 310 has a knurled nut 512 which engages internal threads 520. The assembly 550 protrudes along the optical axis 322 from the end 314 of telescope 320. CCD detector 560 receives a real image from telescope 320 and in response generates a digital image of physical objects viewed by telescope 320.

Turning now to FIG. 6, fork mount 612 is shown, along with right ascension axis 170. Telescope 320 is swung in declination coordinates by rotation about axis 350 (not shown in FIG. 6).

Assembly 550 is shown colliding with base 610 of fork mount 612, as the telescope 320 is swung about axis 350 into a declination position near 90 degrees declination. Assembly 550 strikes base 610 of fork mount 612 thereby preventing the telescope from swinging into declination settings of, in an exemplary embodiment, 75 degrees to 80 degrees. Accordingly, a region of sky of conical shape of between 10 degrees to 15 degrees (half apex angle) cannot be observed using optical component assembly 550 in a fork mounted telescope such as fork mount 612. Accordingly, FIG. 6 gives a clear illustration of the problem solved by the present novel invention.

Panel 622 provides electrical connection to the computer and motors built into fork mount 612. Electrical connection is made through cables 624 and 626.

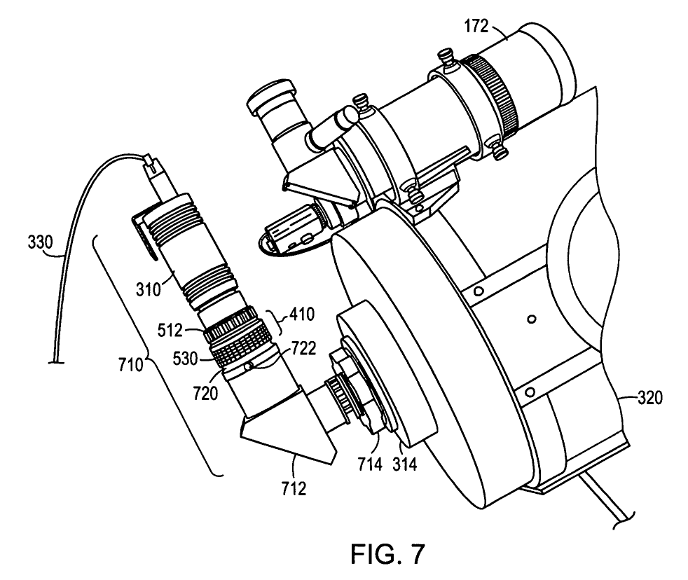

Turning now to FIG. 7, the inventive optical component assembly 710 is shown attached to end 314 of telescope 320. Reflective optical component 712 couples to end 314 by knurled nut 714 engaging threads 540 (not shown in FIG. 7) of end 314. Cylindrical coupling 720 couples into reflective optical component 712. Cylindrical coupling 720 is just barely visible in FIG. 7. Cylindrical coupling 720 is held in rigid relationship with reflective optical component 712 by means of setscrew 722, as is shown more clearly hereinbelow.

Focal reducer/field flattener 410 engages cylindrical coupling 720 by knurled nut 530 engaging its internal threads 532 with external threads formed on cylindrical coupling 720, as shown more clearly hereinbelow.

CCD camera 310 attaches by knurled nut 512 engaging its internal threads 514 with external threads 520 of focal reducer/field flattener 410.

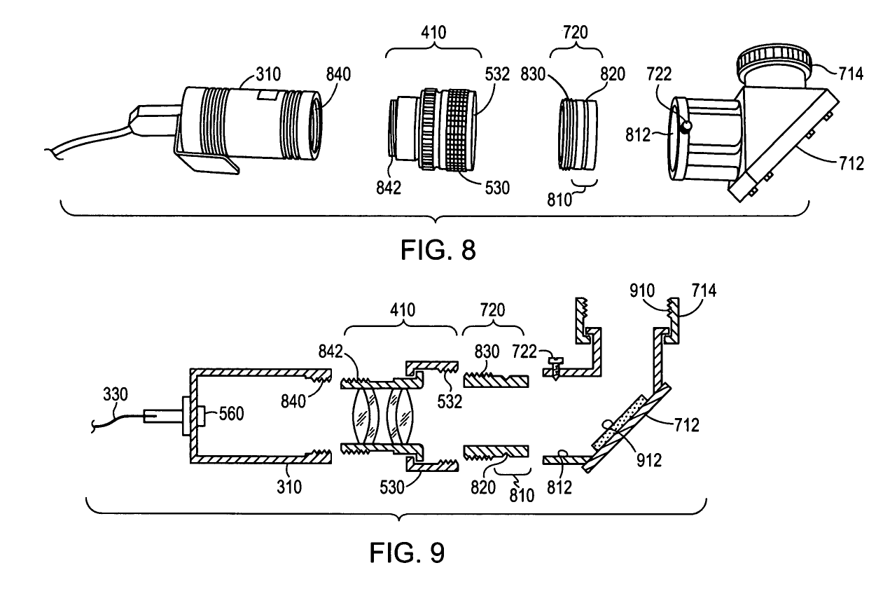

Turning now to FIG. 8, an exemplary embodiment of the novel inventive design is shown in exploded view. Reflective optical component 712 attaches to telescope 320 by knurled nut 714, with internal threads of knurled nut 714 (not shown in FIG. 8) engaging external threads 540 (not shown in FIG. 8, shown in FIG. 5) formed on end 314 of telescope 320.

Cylindrical coupling 720 has external sliding coupling surface 810 which engages internal sliding coupling surface 812 of reflective optical component 712. Setscrew 722 engages groove 820 in order to firmly attach cylindrical coupling 720 to reflective optical component 712.

Cylindrical coupling 720 has external threads 830 to engage internal threads 532 (shown in FIG. 5) of knurled nut 530 in order attach focal reducer/field flattener 410 to cylindrical coupling 720.

In the exemplary embodiment of the invention shown in FIG. 8, CCD camera 310 has internal threads 840 to engage external threads 842 of focal reducer/field flattener 410.

Turning now to FIG. 9, a cross sectional drawing showing the optical components of FIG. 8 is shown. Knurled nut 714 has internal threads 910 which engage external threads 540 of end 314 of telescope 320 (shown in FIG. 5) in order to attach reflective optical component 712 to telescope 320. Reflective optical component 712 has mirror 912 to reflect the primary rays emerging along optical axis 322 of telescope 320 (shown in FIG. 4).

Cylindrical coupling 720 has external cylindrical sliding coupling surface 812 which engages internal sliding coupling surface 812 of reflective optical component 712. External sliding coupling surface 810 also has groove 820 formed therein. Setscrew 722 of reflective optical component 712 engages groove 820 in order form a rigid coupling between reflective optical component 712 and cylindrical coupling 720.

Cylindrical coupling 720 has external threads 830 to engage knurled nut 530 by its internal threads 532, in order to attach focal reducer/field flattener 410 to cylindrical coupling 720.

Focal reducer/field flattener 410 has external threads 842 which engage internal threads 840 of CCD camera 310. CCD detector 560 receives a real optical image from telescope 320 (not shown in FIG. 9), and in response to the real image forms an electronic image of the real optical image. Wire 330 connects CCD camera 310 to its electronic package (not shown in FIG. 9).

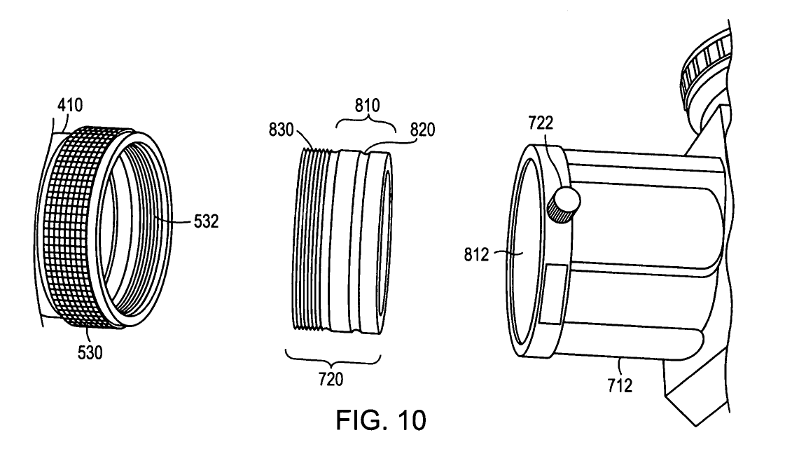

Turning now to FIG. 10, an exploded view of cylindrical connector 720 is shown, along with reflective optical component 712 and with knurled nut 530 of focal reducer/field flattener 410. Internal sliding coupling surface 810 of reflective optical component 712 engages external cylindrical sliding coupling surface 810, and setscrew 722 engages groove 820 in order to form a rigid coupling between reflective optical component 712 and cylindrical connector 720.

External threads 830 of cylindrical connector 720 engage the internal threads 532 of knurled nut 530 in order to form a rigid connection between cylindrical connector 720 and focal reducer/field flattener 410.

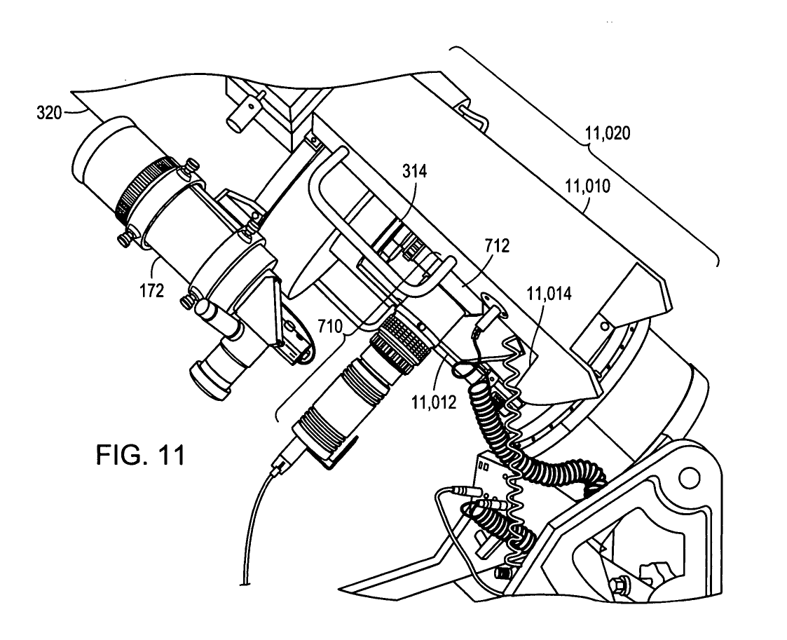

Turning now to FIG. 11, optical assembly 710 with reflective optical component 712 is shown attached as in FIG. 7 to end 314 of telescope 320, and with telescope 320 mounted between arm 11,010 of fork mount 11,020 and the other arm 11,012. The telescope 320 is set to the 90 degree declination position. Optical assembly 710 clears base 11,014 with space to spare, thereby permitting the telescope 320 to be turned into the 90 degree declination position.

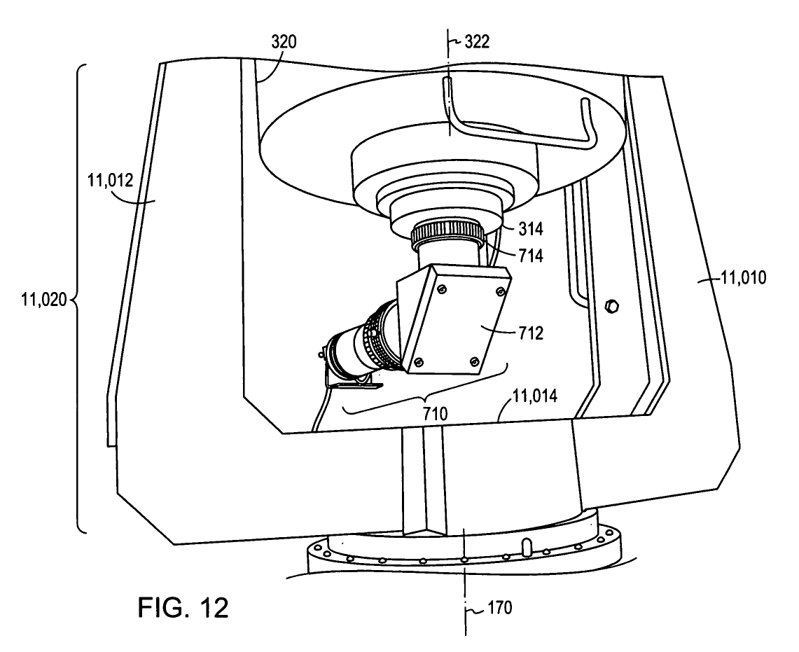

Turning now to FIG. 12, a rear view of the telescope 320 in the 90 degree declination position is shown. Optical assembly 710, with reflective optical component 712, is shown to have ample clearance from base 11,014 of fork mount 11,020. Knurled knob 714 has its internal threads 910 (FIG. 9) engaged with external threads 540 (FIG. 5) of end 314 of telescope 320.

In the 90 degree declination position, rotation axis 170 for right ascension rotation is seen to be coincident with the optical axis 322 of telescope 320.

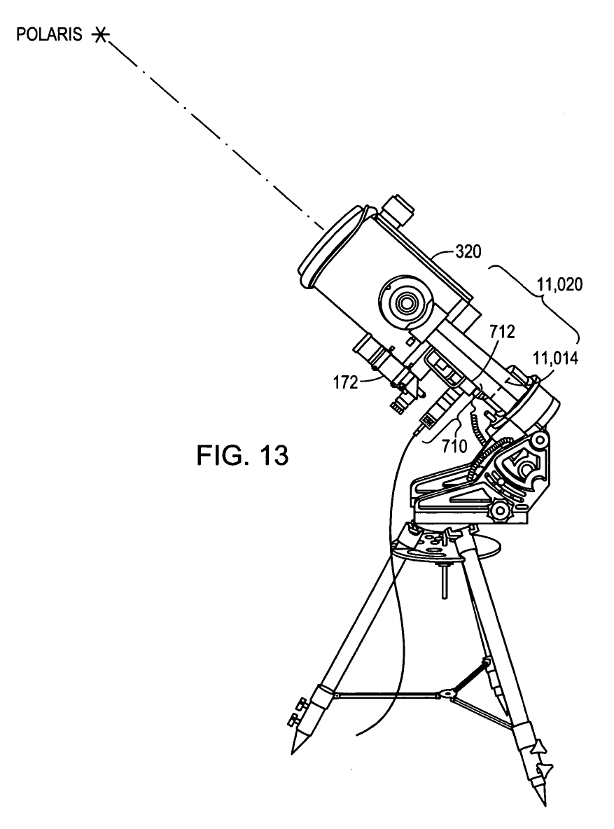

Turning now to FIG. 13, the telescope 320 is shown pointing at Polaris. Optical assembly 710, with reflective optical component 712, is shown to clear base 11,014 (shown as a dashed line to indicate a hidden line) of fork mount 11,020.

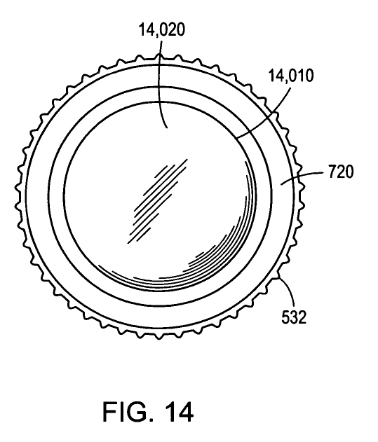

Turning now to FIG. 14, an end view of focal reducer/field flattener 410 and cylindrical connector 720 screwed together by the internal threads 532 (not shown in FIG. 14) of knurled nut 530 fully engaged with the external threads 830 (not shown in FIG. 14) of cylindrical connector 720 is shown. Stop 14,010 holds lens 14,020. Stop 14,010 limits the optical acceptance of the focal reducer/field flattener 410. As is shown in FIG. 14, cylindrical connector 720 does not introduce a reduction of stop in the optical system 710. Further, the short amount of extra length introduced in the optical path by cylindrical connector 720, as shown in FIG. 7, and as reinforced by FIG. 8 and FIG. 9, is not sufficient to introduce vignetting in the real prime image cast onto CCD detector 560 as shown in FIG. 9.

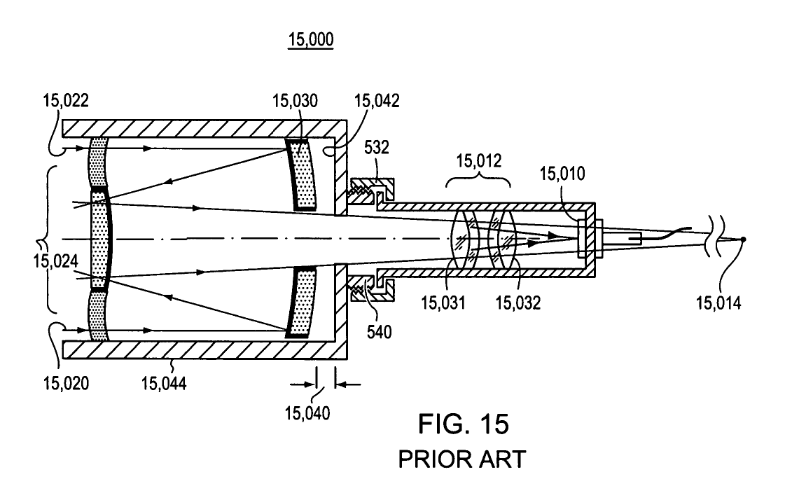

Turning now to FIG. 15, an optical ray diagram 15,000 of a Cassegrain type telescope is shown. A prior art arrangement of the CCD detector arranged along with a focal reducer/field flattener 15,012 is shown.

Rays of light 15,020 and 15,022 enter the telescope through front plate 15,024. The rays are reflected by primary mirror 15,030 and are focused to focal point 15,014. The lenses 15,030 and 15,032 further focus the rays to a focal point on the CCD detector 15,010, thereby reducing the focal length of the telescope system. It is desirable to reduce the focal length of the telescope system, in order to increase the brightness of the light reaching the CCD detector. An increase in brightness of light reaching the CCD detector 15,010 permits a shorter exposure to form an electronic image by the CCD detector.

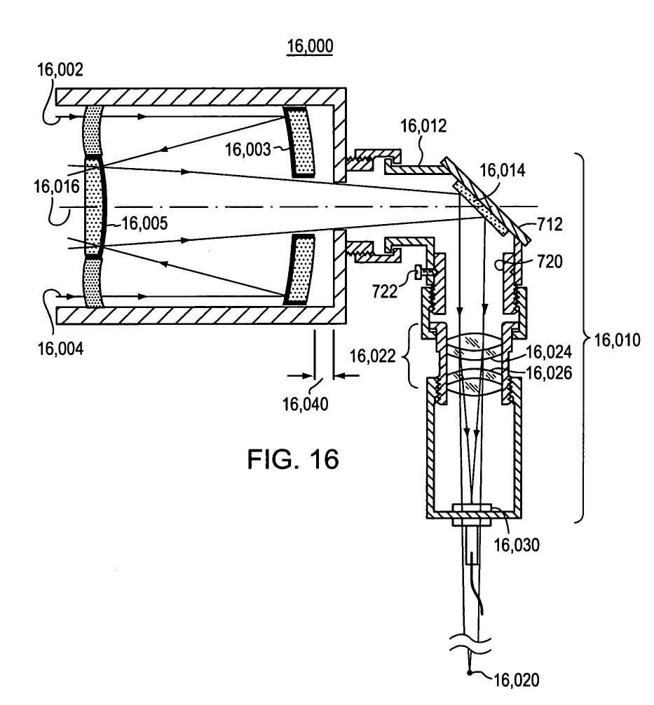

Turning now to FIG. 16, a telescope system 16,000 using the inventive optical system 16,010 is shown. Substantially parallel light rays 16,002 and 16,004 enter the telescope from a distant object. The light rays 16,002 and 16,004 are reflected by primary mirror 16,003, then are reflected by secondary mirror 16,005, and are focused at point 16,020.

A reflecting optical element 16,012 has a mirror 16,014 set at 45 degrees to the optical axis 16,016 of the telescope, to bend the ray path by 90 degrees to a focal point 16,020. Focal reducer 16,022 has lenses 16,024 and 16,026 which focus the rays to converge to a focal point at the CCD detector 16,030. CCD detector 16,030 then creates an electronic image of the objects producing the light rays. Again, as in the prior art discussed with reference to FIG. 15, it is desirable to reduce the focal length of the telescope system, in order to increase the brightness of the light reaching the CCD detector. An increase in brightness of light reaching the CCD detector 15,010 permits a shorter exposure to form an electronic image by the CCD detector.

The advantage of the inventive optical system of FIG. 16 is that the telescope system, including the inventive optical system 16,010 fits within the base of the forks of a fork mount system, and so the CCD detector 16,030 can be used to image the portion of sky containing Polaris.

As a result of being able to image Polaris by the CCD detector 16,030, the region of sky near 90 degrees declination is available for electronic imaging.

Yet another advantage of being able to image Polaris by the CCD detector 16,030 is that alignment of the telescope may be automated by: first, arranging motors to adjust the altitude of the telescope mount by adjusting screw 150; and second arranging motors to drive the azimuth adjusting screws 220 and 230 of the telescope mount. With remote control of the adjustment of the telescope as explained in the Background section hereinabove, it is possible to remotely bring the telescope into operation, and to make small adjustments in the altitude and azimuth settings of the mount of the telescope to keep the telescope in operation. For example, all regions of the sky can be studied remotely, with the operator in a laboratory miles from the location of the telescope. In an amateur astronomy setting, the telescope can be operated, using the inventive optical system 16,010, from a room which is comfortable when the telescope is located a few yards away in an environment of extreme cold, extreme heat, or when clouds of mosquitoes are swarming, etc.

Still another advantage of the invention is that it makes re-focussing of the primary mirror of the telescope easier when an observer switches between eyepiece observation and CCD camera observation. Without the invention an observer must use eyepiece 160 (FIG. 1) in order to observe Polaris when adjusting the forks to point to the celestial pole 120, as described in the Background Section. Referring now to FIG. 7 and FIG. 9, in the prior art setscrew 722 is used to hold eyepiece 160 in place in coupling surface 812 (not shown). In the event that the observer desires to do CCD camera imaging of stars, then after the forks are adjusted to point to the celestial pole, the observer must unscrew threads 910 (FIG. 9) holding reflective element 712 in place, and screw threads 532 (FIG. 5) into threads 540 of end 314 of telescope 320 in order to achieve the prior art configuration of FIG. 15.

When the change from eyepiece 160 observation to CCD detector 15,010 imaging is done, then the primary mirror 15,030 must be moved in order to move the location of the prime focus (not shown) of the telescope. The prime focus of the telescope is moved by moving the primary mirror 15,030, and the motion of the primary mirror 15,030 required is to change the distance 15,040 between the primary mirror 15,030 and the rear wall 15,042 of the telescope tube 15,044. Distance 15,040 is changed in many commercial telescopes by an electric motor (not shown), and the motor is often operated by the observer pressing a switch button for the length of time required to change distance 15,040 by the required amount. Often, in many commercially available telescopes, it may take as much as five (5) minutes to move the mirror sufficiently to move the primary focal point of the telescope sufficiently to go from focus with eyepiece 160 to focus onto CCD detector 15,010, as the motors usually are designed to move the mirror slowly.

With use of the invention, eyepiece 160 observation may be conducted, both at declination of 90 degrees as shown in FIG. 1, or at any other declination (not shown), and then the eyepiece removed and the inventive cylindrical coupling 720 inserted into reflective element 712, as shown in FIG. 16, and secured by setscrew 722. Again, primary mirror 16,003 must be moved by the use of the motor drive (not shown) in order to change distance 16,040 in order to move the focal point of primary mirror 16,003 from the eyepiece 160 inserted into reflective element 712 (not shown) to the CCD detector 16,030 as shown in FIG. 16. The distance which the focal point must be moved, and consequently the amount by which distance 16,040 must be changed in going from eyepiece observation to CCD imaging as shown in FIG. 16, is often much less than in the prior art. Accordingly, it is much easier for an observer to switch from eyepiece observation using reflective element 712 (as shown in FIG. 1) to CCD imaging using the inventive cylindrical coupling 720 as shown in FIG. 16, than it was in the prior art.

Further, with the inventive cylindrical coupling 720 the telescope is adjusted for the forks to point to the celestial pole using the CCD detector 16,030, and is then used at any right ascension or declination for further CCD imaging, without any need to adjust the position of primary mirror 16,003; that is, distance 16,040 need not be changed between adjustment of the forks by CCD imaging, and further CCD imaging. Thus both adjustment of the fork mount and further observation may be done remotely, as described hereinabove, using a computer or television image produced by the CCD detector 16,030.

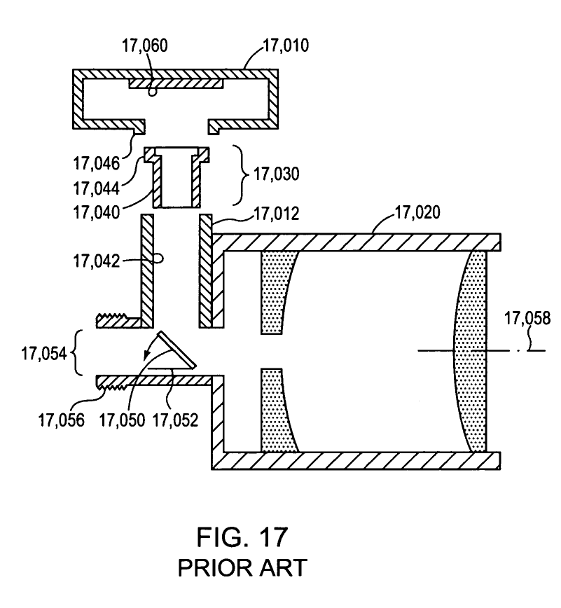

Turning now to FIG. 17, prior art designed to couple a camera 17,010 to an eyepiece holder 17,012 of a telescope 17,020 is shown. A cylindrical coupling 17,030 is designed to slip into the eyepiece holder 17,012, instead of the actual eyepiece (not shown). The exterior sliding surface 17,040 of cylindrical coupling 17,042 slides into the interior sliding surface 17,042 of the eyepiece holder 17,012. An eyepiece is normally slid into position within eyepiece holder 17,012 by sliding it into interior sliding surface 17,042.

Ring 17,044 has a form of mating surface which attaches to a mating ring 17,046 of camera 17,010. For example, ring 17,044 and mating ring 17,046 may be “T mounts” of the type used to attach 35 millimeter film cameras to interchangeable lenses, in the event that camera 17,010 is a 35 millimeter film camera. As another example, camera 17,010 may be a commercial digital camera, and in this event the camera may have a lens (not shown) within ring 17,046, and then ring 17,044 and ring 17,046 will traditionally have threads to screw together.

The telescope 16,000 has an internal flip mirror which can be placed in position 17,052 in order to have the real prime image formed by light rays passing through opening 17,054. External threads 17,056 may be used to attach a camera for prime focus imaging, or may be used to attach another optical accessory,. Alternatively, mirror 17,050 may be placed in the position shown as position 17,050, which is at a 45 degree angle to the telescope optical axis, so that the optical axis of the telescope is changed by 90 degrees, so that a real image can be formed on sensitive element 17,060 in camera 17,010. Sensitive element 17,060 may be photographic film, or may be a CCD detector to form an electronic image of the real image produced by telescope 17,020, etc.

It is to be understood that the above described embodiments are simply illustrative of the principles of the invention. Various other modifications and changes may be made by those skilled in the art which embody the principles of the invention and fall within the spirit and scope thereof

1. A telescope system, comprising:
a telescope having a tube, a prime focusing mirror, and a secondary mirror on the optical axis of the telescope to form a real image behind the telescope, the prime focusing mirror located at a first end of the tube;
a fork mount, the fork mount having a base and a first arm extending from a first end of the base and a second arm extending from a second end of the base;
an axle to rotate the fork mount along a first axis perpendicular to the base and parallel to the arms, the base rotating about a location midway between the two arms, to cause the fork to rotate in right ascension when the axis points toward a celestial pole;
rotatable attachments to permit rotating the tube in a plane midway between the two arms of the fork mount, the plane substantially perpendicular to the base of the fork mount, to cause the tube to rotate in declination when the axis points toward a celestial pole;
a 45 degree angle reflector to deflect the optical axis of the telescope by 90 degrees so that the real image is formed on a line perpendicular to the optical axis of the telescope tube, the 45 degree angle reflector attaching to external threads at the first end of the telescope tube;
a cylindrical coupling member mating at a first end with a downstream opening of the 45 degree angle deflector, and a threaded coupling at a downstream end of the cylindrical coupling;
a field adjuster, the field adjuster attached to the threaded coupling of the cylindrical coupling; and
a CCD camera attached to a downstream end of the field adjuster, wherein the field adjuster and the CCD camera clear the base of the fork mount when the telescope is in the 90 degree declination position.

2. A telescope system as in claim 1, further comprising:
a smooth internal mating surface in the downstream end of the 45 degree angle reflector;
a smooth external mating surface in the first end of the cylindrical coupling member, the smooth external mating surface fitting into the smooth internal mating surface of the 45 degree angle reflector.

3. A telescope system as in claim 2, further comprising:
a grove in the cylindrical coupling member;
a setscrew in the 45 degree angle reflector, the setscrew mating with the grove to hold the cylindrical coupling member securely in place.

4. A telescope, comprising:
a tube, a prime focusing mirror, and a secondary mirror to form a real image behind the telescope;
a fork mount having a base and a two arms extending to hold the telescope tube;
a 45 degree angle reflector deflects light from the telescope by 90 degrees, the 45 degree angle reflector attaching to external threads at an end of the telescope tube;
a cylindrical coupling member mated at a first end with a downstream opening of the 45 degree angle deflector, and having a threaded coupling at a downstream end of the cylindrical coupling; and
a CCD camera attached to a downstream end of the cylindrical coupling member, so that the CCD camera clears the base of the fork mount when the telescope is in the 90 degree declination position.

5. The telescope as in claim 4, further comprising:
a field adjuster, the field adjuster attached to the threaded coupling of the cylindrical coupling member at a first end, and the field adjuster attached at a second end to the CCD camera.

6. A telescope system as in claim 5, further comprising:
a smooth internal mating surface in the downstream end of the 45 degree angle reflector;
a smooth external mating surface in the first end of the cylindrical coupling member, the smooth external mating surface fitting into the smooth internal mating surface of the 45 degree angle reflector.

7. A telescope system as in claim 6, further comprising:
a grove in the cylindrical coupling member;
a setscrew in the 45 degree angle reflector, the setscrew mating with the grove to hold the cylindrical coupling member securely in place.

8. A telescope system, comprising:
a telescope having a tube, a prime focusing mirror, and a secondary mirror on the optical axis of the telescope to form a real image behind the telescope, the prime focusing mirror located at a first end of the tube;
a fork mount, the fork mount having a base and a first arm extending from a first end of the base and a second arm extending from a second end of the base;
an axle to rotate the fork mount along a first axis perpendicular to the base and parallel to the arms, the base rotating about a location midway between the two arms, to cause the fork to rotate in right ascension when the axis points toward a celestial pole;
rotatable attachments to permit rotating the tube in a plane midway between the two arms of the fork mount, the plane substantially perpendicular to the base of the fork mount, to cause the tube to rotate in declination when the axis points toward a celestial pole;
a 45 degree angle reflector to deflect the optical axis of the telescope by 90 degrees so that the real image is formed on a line perpendicular to the optical axis of the telescope tube, the 45 degree angle reflector attaching to external threads at the first end of the telescope tube, and a smooth internal mating surface in the downstream end of the 45 degree angle reflector;
a cylindrical coupling member mating at a first end with a downstream opening of the 45 degree angle deflector, and a threaded coupling at a downstream end of the cylindrical coupling, a smooth external mating surface in the first end of the cylindrical coupling member, the smooth external mating surface fitting into the smooth internal mating surface of the 45 degree angle reflector, and a grove in the cylindrical coupling member and a setscrew in the 45 degree angle reflector, the setscrew mating with the grove to hold the cylindrical coupling member securely in place.
a field adjuster, the field adjuster attached to the threaded coupling of the cylindrical coupling; and
a CCD camera attached to a downstream end of the field adjuster, wherein the field adjuster and the CCD camera clear the base of the fork mount when the telescope is in the 90 degree declination position.
